(19) United States
(12) Patent Application Publication
(10) Pub. No.: US 2026/0154099 A1
(43) Pub. Date: Jun. 4, 2026

(54) QUICKLY MIGRATING A CONTAINER AND DATA TO A NEW SERVER

(71) Applicant: INTERNATIONAL BUSINESS MACHINES CORPORATION, ARMONK, NY (US)

(72) Inventors: Yu Zui You, Ningbo (CN); Zhan Peng Huo, Beijing (CN); Xiao Ling Chen, Beijing (CN); Heng Wang, Beijing (CN)

(21) Appl. No.: 18/964,898

(22) Filed: Dec. 2, 2024

(51) Int. Cl. G06F 9/455

(52) U.S. Cl. CPC G06F 9/45558; G06F 2009/4557; G06F 2009/45575

(57) ABSTRACT

An approach is provided for quick container migration. Image metadata is retrieved from an image of a container being migrated from an old to a new server. Container migration-related information is extracted from the image metadata and the extracted information is analyzed. A new manifest is created that includes migration information based on the analyzed extracted information. Metadata of the container is analyzed and a new startup command is generated by combining the analyzed metadata of the container with other metadata of the container, new service port information, and disk usage information. Based on the analyzed metadata of the container, media including disks and images are uploaded to a directory in the new server. A service is started in the new server by running the new startup command. A startup of the container in the new server is verified.

### BACKGROUND

The present invention relates to containers, and more particularly to migrating container applications to a new server.

### SUMMARY

In one embodiment, the present invention provides a computer-implemented method. The method includes retrieving image metadata from an image of a container being migrated from an old server to a new server. The method further includes extracting information from the retrieved image metadata, where the extracted information is related to migrating containers. The method further includes analyzing the extracted information. The method further includes creating a new manifest that includes migration information based on the analyzed extracted information. The method further includes analyzing metadata of the container. The method further includes generating a new startup command by combining the analyzed metadata of the container with other metadata of the container, new service port information, and disk usage information. The method further includes, based on the analyzed metadata of the container, uploading media including disks and images to a directory in the new server. The method further includes starting a service in the new server by running the new startup command. The method further includes verifying a startup of the container in the new server, where the startup includes starting the service.

A computer system and a computer program product corresponding to the above-summarized computer-implemented method are also described herein.

### BRIEF DESCRIPTION OF THE DRAWINGS

FIG. 1 is a block diagram of a system for quickly migrating a container and data to a new server, in accordance with embodiments of the present invention.

FIG. 2 is a block diagram of modules included in code included in the system of FIG. 1, in accordance with embodiments of the present invention.

FIG. 3 is a flowchart of a process of quickly migrating a container and data to a new server, where operations of the flowchart are performed by modules in FIG. 2, in accordance with embodiments of the present invention.

FIG. 4 is a block diagram of an overall workflow that uses modules in FIG. 2 to perform operations in the process of FIG. 3, in accordance with embodiments of the present invention.

FIG. 5 is an example of a special data structure used to create a new manifest in the process of FIG. 3, in accordance with embodiments of the present invention.

FIG. 6 is an example of operations performed by the container analysis module, which is included in the modules in FIG. 2, and where the operations are included in the process of FIG. 3, in accordance with embodiments of the present invention.

FIG. 7 is an example of operations performed by the container migration module, which is included in the modules in FIG. 2, and where the operations are included in the process of FIG. 3, in accordance with embodiments of the present invention.

FIG. 8 is an example of additional details of the operations performed by the container migration module in FIG. 7, in accordance with embodiments of the present invention.

FIG. 9 is an example of operations performed by the container verification module, which is included in the modules in FIG. 2, and where the operations are included in the process of FIG. 3, in accordance with embodiments of the present invention.

### DETAILED DESCRIPTION

### Overview

Due to an outdated system caused by server system upgrades, data center migration changes, and/or other reasons, container applications on an original server need to be migrated to a new server. When using known migration approaches in cases in which the startup command or startup document of the container is lost because of a long-ago creation time of the container, it is impossible to quickly start the container in the new environment and migrate the dataset through the docker compose command. Manual migration in conventional approaches is therefore necessary, which requires a significant amount of time to synchronize and find the startup configuration parameters of the container applications. Moreover, inconsistent versions can also cause migration failures, which result in the new service not being able to start and run normally in the system.

Embodiments of the present invention address the aforementioned unique challenges by rapidly migrating containers and data to a new server by (i) intelligently analyzing and organizing the metadata information of the containers, (ii) automatically generating relevant migration configuration information and relationship mapping, and (iii) migrating the dependencies of related containers, thereby completing the migration of old containers with data to a new server.

In one embodiment, the rapid migration of containers and data includes (i) collecting migration-related information (e.g., port mapping, volume mapping, image, image version, etc.) to create a new manifest with migration information; (ii) analyzing the container metadata and automatically generating the docker run startup command by combining the analyzed container metadata with other container metadata, new service port information, and disk usage information; (iii) using the analysis results to automatically upload relevant media, such as disks and images, to the directory in the new server; (iv) automatically creating a new directory which is modified to the manifest, where the creation of the new directory is based on analyzing directory conflict, and starting the service with a new startup command generated through the manifest; (v) validating the new server through reliable validation methods; and (vi) completing the migration of old containers with data to the new server.

In one embodiment, container analysis, container migration, and container verification modules (i) analyze and extend docker manifest files, (ii) automatically migrate the image, container, and data from an old server to a new server, and (iii) verify the migration by using container probes to validate the new server.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer-readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

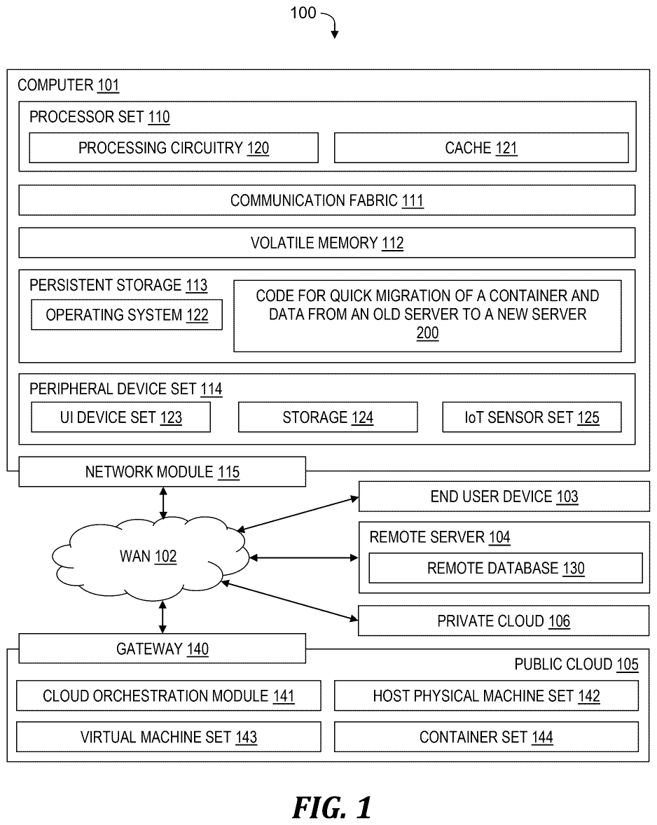

FIG. 1 is a block diagram of a system for quickly migrating a container and data to a new server, in accordance with embodiments of the present invention. Computing environment 100 contains an example of an environment for the execution of at least some of the computer code involved in performing the inventive methods, such as code 200 for a quick migration of a container and data from an old server to a new server. The aforementioned computer code is also referred to herein as computer-readable code, computer-readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

### System and Process for a Quick Migration of a Container and Data From an Old Server to a New Server

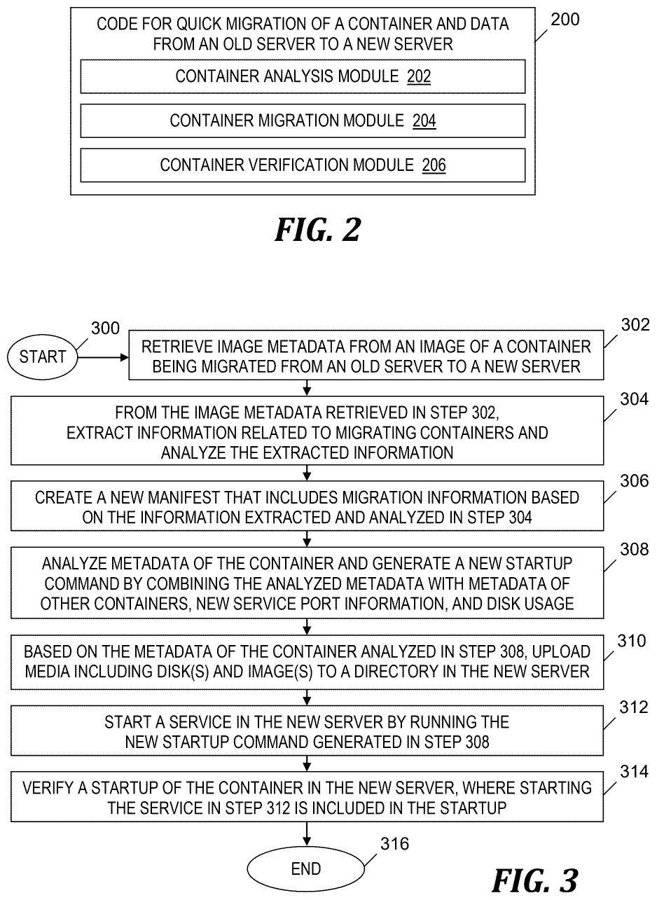

FIG. 2 is a block diagram of modules included in code included in the system of FIG. 1, in accordance with embodiments of the present invention. Code 200 includes a container analysis module 202, a container migration module 204, and a container verification module 206.

Container analysis module 202 is configured to retrieve image metadata information from an image of a container being migrated from a first server (i.e., an old server) to a second server (i.e., a new server). In one embodiment, container analysis module 202 is configured to run a docker inspect command and retrieve image metadata included in the output of the docker inspect command.

Container analysis module 202 is further configured to extract and analyze information related to migrating containers (also referred to herein as migration-related information), where the migration-related information is extracted from the retrieved image metadata. In one embodiment, the extracted migration-related information includes configuration information about the base image, volume mounts, ports, the image version, port mapping, volumes mapping, volume permission, etc.

Container analysis module 202 is further configured to create a new manifest (i.e., a migration manifest) that includes migration information that is based on the extracted and analyzed migration-related information. For example, the migration information included in the new manifest includes details about volume, port, image, app-version, volume permission, and probe, which are required for the migration of the container.

Container migration module 204 is configured to analyze metadata of the container being migrated and to automatically generate a startup command (e.g., a docker run command) by combining the analyzed metadata of the container with other metadata of the container, new service port information, and disk usage information, which is provided by the new manifest.

Container migration module 204 is further configured to detect port conflicts or mounting volume (i.e., disk) conflicts associated with the migration of the container. Container migration module 204 is configured to automatically find available ports or mounting volumes in the new server in response to a conflict being detected.

Container migration module 204 is further configured to detect the software version (i.e., app version or image version) in the case of an update to a previous software version and adding a new tag to the image parameter of the startup command (e.g., docker run command), where the new tag indicates the detected updated software version (e.g., a tag in the format of <old hostname>-<app version>).

Container migration module 204 is further configured to, based on the analyzed metadata of the container, automatically upload relevant media, such as disks and images, to a directory in the new server. If there is a directory conflict, container migration module 204 automatically creates a new directory and modifies the manifest to include the new directory.

Container migration module 204 is further configured to start a service in the new server by executing the aforementioned startup command (e.g., docker run command).

Container verification module 206 is configured to automatically verify the old server through the use of probes, such as httpGet liveProbe, tcpSocket probe, and a pre-defined exec command. In one embodiment, container verification module 206 performs a probe verification method to verify the old server by using software-based probe(s). Container verification module 206 uses a probe to determine whether the migrated container is running successfully (i.e., the container is alive and healthy). If the migrated container is running successfully, then container verification module 206 determines that the migration is healthy and successful, and the migrated container is ready for testing or for being used.

In one embodiment, container verification module 206 verifies the old server by (1) using httpGet liveProbe on the container if an outbound port exists in the old server and then using tcpSocket probe on the container if the httpGet liveProbe fails; or (2) if no outbound port exists in the old server, using a pre-defined exec command to determine that the container running successfully.

Container verification module 206 is further configured to automatically select a probe verification method that is determined to be reliable based on the probe verification method successfully determining that the container is alive and healthy (i.e., the probe verification passes).

Container verification module 206 is further configured to validate the new server through reliable validation methods (e.g., a probe verification method determined to be reliable). If the validation of the new server fails, an abnormal container startup in the new server is indicated and container migration module 204 and container verification module 206 repeat the migration and validation steps, respectively, for the container.

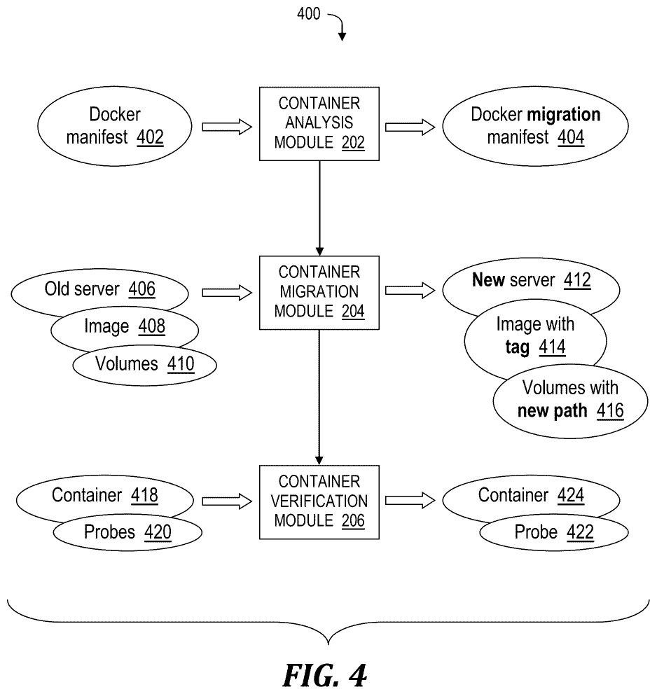

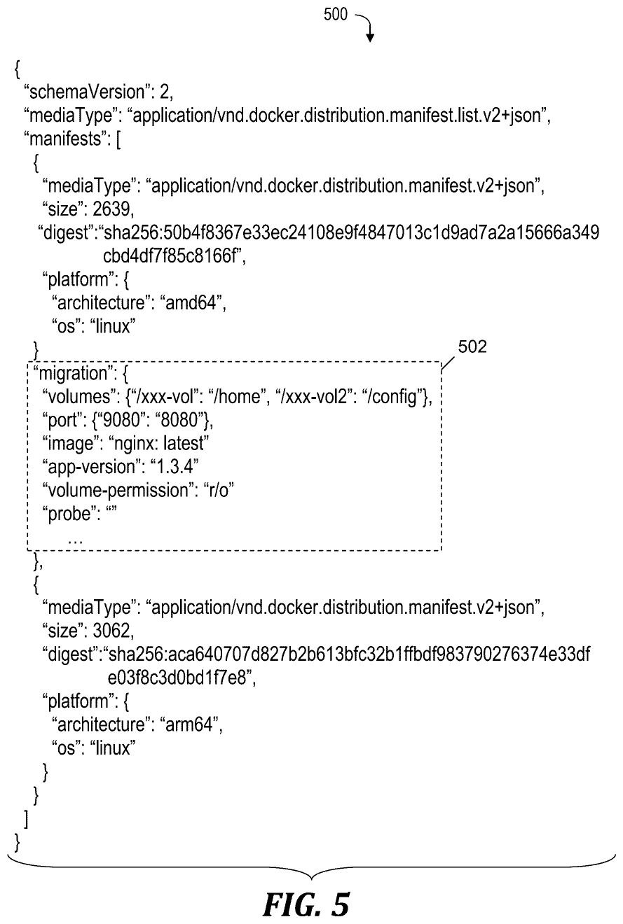

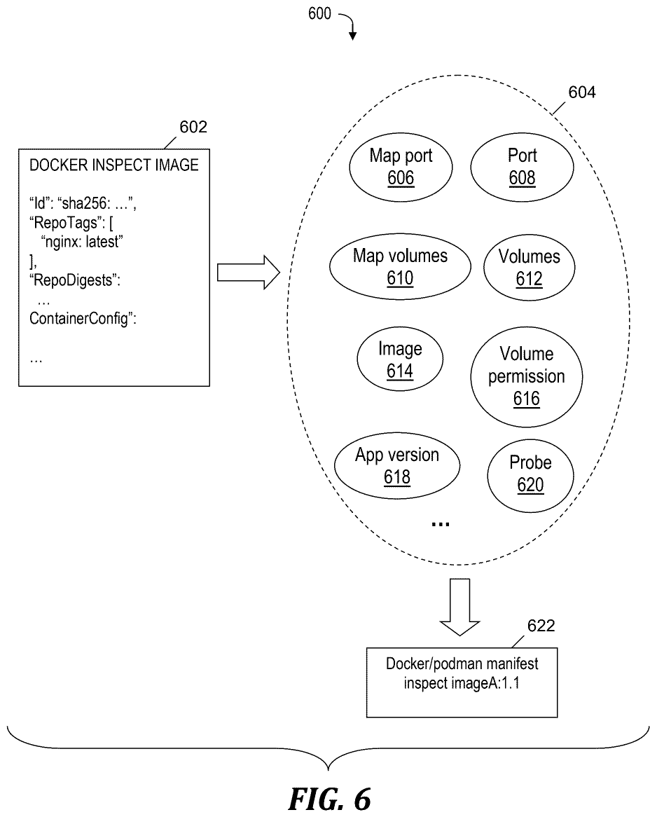

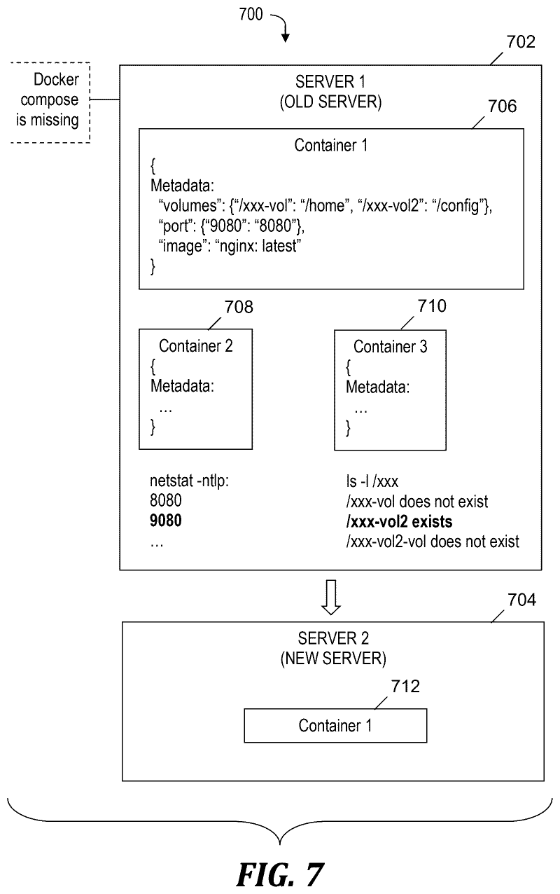

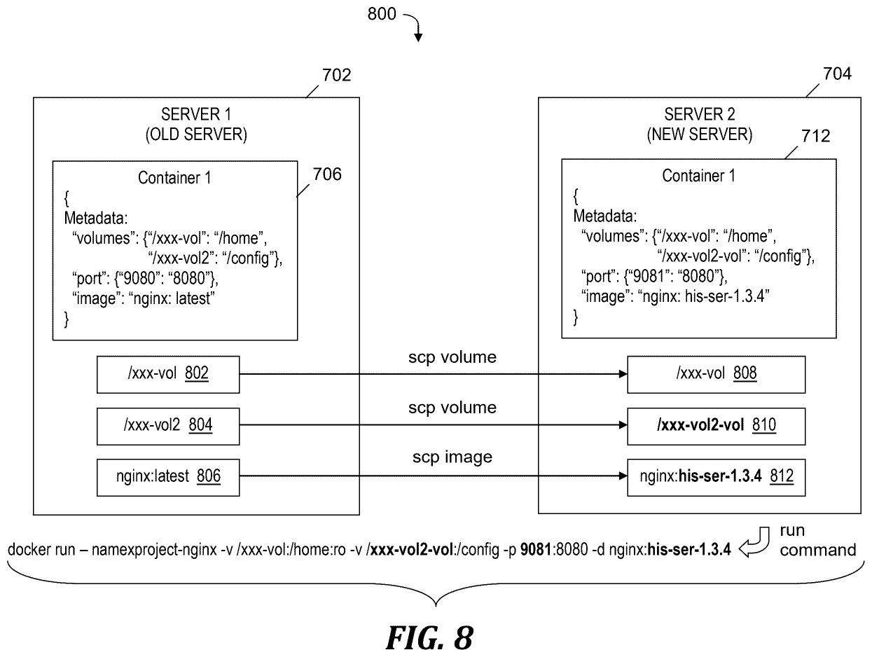

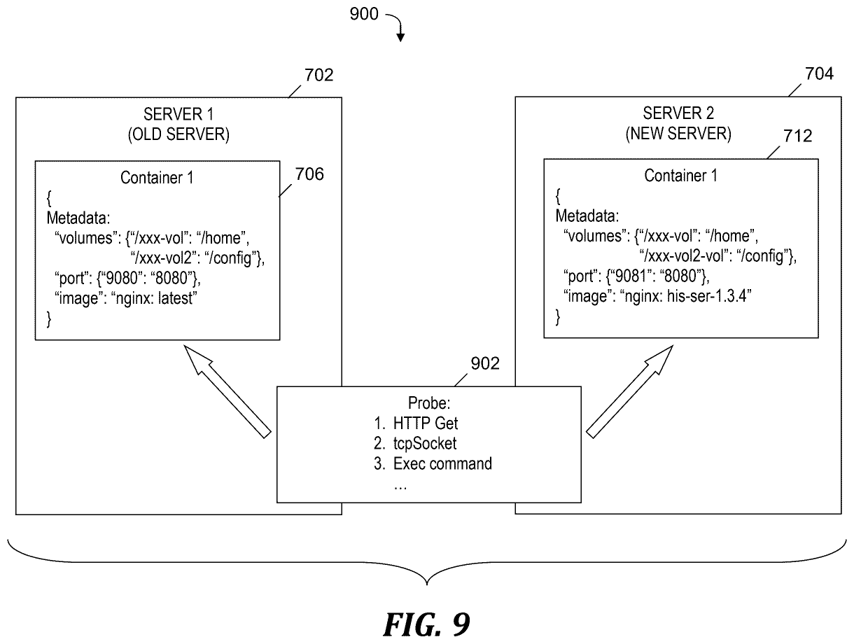

The functionality of the modules included in code 200 is described in more detail in the discussions presented below relative to FIG. 3, FIG. 4, FIG. 5, FIG. 6, FIG. 7, FIG. 8, and FIG. 9.

FIG. 3 is a flowchart of a process of quickly migrating a container and data to a new server, where operations of the flowchart are performed by modules in FIG. 2, in accordance with embodiments of the present invention. The process of FIG. 3 begins at a start node 300. A container is running in an old server, the old server needs to be shut down or moved to another location, and therefore, the services running in the container in the old server need to be moved from the old server to a new server via a migration of the container to the new server. Prior to step 302, the container being migrated from the old server to the new server is generated by a compose command (e.g., a docker compose command) or by another command or by configuration files that specify how to configure and start the container and further specify a sequence in which multiple containers are started. Furthermore, the compose files resulting from running the compose command or the aforementioned configuration files are missing and are not accessible at the time the migration of the container is required. The migration of the container from the old server to the new server therefore does not use the missing compose files or configuration files, but instead uses the novel approach described in the process of FIG. 3.

In step 302, container analysis module 202 retrieves image metadata from an image of a container being migrated from an old server to a new server.

In step 304, container analysis module 202 extracts and analyzes information from the image metadata retrieved in step 302, where the extracted information is related to container migration.

In step 306, container analysis module 202 creates a new manifest that includes migration information based on the information extracted and analyzed in step 304.

In step 308, container migration module 204 analyzes metadata of the container being migrated and generates a new startup command (e.g., docker run command) by combining the analyzed metadata with other metadata of the container, new service port information, and disk usage information.

In step 308, container migration module 204 also detects any conflicts that exist, where a conflict indicates that a port or disk used in the old server is already occupied in the new server prior to the completion of the migration of the container to the new server. If container migration module 204 detects that a conflict exists, then container migration module 204 automatically finds a new port or disk that is available on the new server and can be used to complete the migration of the container.

In step 308, container migration module 204 also detects the software version of the image of the container being migrated and automatically adds a new tag to the image parameter of the new startup command, where the new tag indicates the detected software version.

In step 310, container migration module 204, based on the metadata of the container analyzed in step 308, uploads media including disk(s) and image(s) to a directory in the new server. Container migration module 204 determines whether there is a directory conflict, and if a directory conflict exists, container migration module 204 automatically creates a new directory and modifies the manifest with the newly created directory.

In step 312, container migration module 204 starts a service in the new server by running the new startup command generated via the new manifest.

In step 314, container verification module 206 verifies a startup of the container in the new server, where starting the server in step 312 is included in the startup being verified. In step 314, container verification module 206 automatically verifies the old server through the use of a software-based probe, which implements the following verification rules:
(1) If an outbound port exists, use httpGet liveProbe to validate the container, and then use a tcpSocket probe if the httpGet liveProbe fails.
(2) If no outbound port exists, then validate the container by using a pre-defined exec command.

In step 314, container verification module 206 automatically selects a probe verification method. If the probe verification passes, this is an indication that the verification method is reliable.

In step 314, container verification module 206 validates the new server through reliable validation methods. If the validation fails, then an abnormal container startup is indicated and container migration module 204 and container verification module 206 repeat the container migration and validation, respectively.

In response to the container verification module validating the services provided by the migrated container in new server, the computer system that includes modules 202, 204 and 206 safely shuts down the old server. Subsequently, the computer system calls the migrated container in the new server to provide the aforementioned services to users.

FIG. 4 is a block diagram of an overall workflow 400 that uses modules in FIG. 2 to perform operations in the process of FIG. 3, in accordance with embodiments of the present invention. Workflow 400 includes container analysis module 202, container migration module 204, and container verification module 206. Container analysis module 202 receives a docker manifest 402 (e.g., a JavaScript® Object Notation (JSON) file that stores metadata for a group of files that comprise a container image). JavaScript is a registered trademark of Oracle America, Inc. located in Redwood Shores, California.

Container analysis module 202 generates a docker migration manifest 404 (also referred to herein as the new manifest) by using docker manifest 402.

Container migration module 204 analyzes metadata from docker migration manifest 404, including information about old server 406, image 408 (i.e., the image of the container in the old server), and volumes 410 (i.e., the volumes specified by the container in the old server). Container migration module 204 uses old server 406, image 408, and volumes 410 received from the migration manifest, a detection of any conflicts in ports or volumes, a determination of an updated software version for the image, and a generation of a tag that indicates the updated software version to generate a new server 412, an image with tag 414, and volumes with new path 416. New server 412 is the server to which the container is being migrated. Image with tag 414 is the identifier of the image of the container in new server 412 combined with the tag that indicates the updated software version. Volumes with new path 416 specifies the new path for volumes in the new server 412 that resolve previously detected volume conflicts.

Container verification module 206 verifies container 418 on old server 406 by using probes 420 to determine a reliable verification method. Container verification module 206 uses the reliable verification method that employs probe 422 (which is included in probes 420) to validate container 424 in new server 412.

FIG. 5 is an example of a special data structure 500 used as a new image manifest in the process of FIG. 3, in accordance with embodiments of the present invention. Special data structure 500 is a result of an inspect command (e.g., a docker inspect command or a podman inspect command) and includes a new migration section 502 that includes new parameters specifying the following information needed for the migration of the container: volumes mapping, port mapping, image mapping, app version mapping, volume permission mapping, and probe. The new parameters in FIG. 5 are not included in a conventional manifest file.

### EXAMPLES

FIG. 6 is an example 600 of operations performed by the container analysis module, which is included in the modules in FIG. 2, and where the operations are included in the process of FIG. 3, in accordance with embodiments of the present invention. Container analysis module 202 retrieves image metadata information 602 from a docker inspect image command. Container analysis module 202 extracts and analyzes migration related information 604 from the metadata information 602. The migration related information 604 includes map port 606, port 608, map volumes 610, volumes 612, image 614, volume permission 616, app version 618, and probe 620. Container analysis module 202 creates a new manifest with migration information based on the extracted migration related information 604 by using a docker or podman manifest inspect imageA:1.1 command 622, which results in the data structure shown in FIG. 5.

FIG. 7 is an example 700 of operations performed by the container migration module, which is included in the modules in FIG. 2, and where the operations are included in the process of FIG. 3, in accordance with embodiments of the present invention. Example 700 includes an old server 702 (also referred to as Server 1) and a new server 704 (also referred to as Server 2). Old server 702 includes a container 706 (also referred to as Container 1 in old server 702), container 708 (also referred to as Container 2), and container 710 (also referred to as Container 3). New server 704 includes a container 712 (also referred to as Container 1 in new server 704), which is the result of migrating container 706 from old server 702 to new server 704.

Container 706 is originally generated by a docker compose command, but at the time the migration is required, the docker compose files for container 706 are missing and are not accessible and therefore cannot be used to perform the migration of container 706 to new server 704. Container migration module 204 analyzes metadata of the container and automatically generates a docker run command (i.e., a startup command). The analysis of the metadata of the container includes detecting conflicts associated with ports and/or disks (e.g., an identifier of a port or a volume used by container 706 in old server 702 is not available in new server 704 because that identifier is being used by another container that is already in the new server 704). The analysis of the metadata of the container further includes detecting an updated software version for the image of the container. Analyzing the metadata in container 706, container migration module 204 determines that there is one conflict with port 9080 and another conflict with the volume /xx-vol2 (i.e., port 9080 and volume /xx-vol2 already exist and are occupied by other services in new server 704 prior to the migration of container 706). Further, container migration module 204 determines that port 8080 and volume /xx-vol, which are included in the metadata of container 706, do not already exist in new server 704 and are therefore available to use by container 712 after the migration. Container migration module 204 automatically determines that port 9081 is available in new server 704, so container 712 exposes its service via port 9081 instead of port 9080 after the migration. Further, container migration module 204 automatically determines that volume /xx-vol2-vol is available in new server 704 to be used by container 712 after the migration instead of the already occupied /xx-vol2. Still further, container migration module 204 determines an updated software version of his-ser-1.3.4. Subsequent to the metadata analysis, container migration module 204 generates a docker run command using port 9081, volume /xx-vol2-vol, and software version his-ser-1.3.4, as shown in boldface in the command presented below:

docker run--name xproject-nginx-v /xx-vol:/home: ro-v /xx-vol2-vol:/config-p 9081:8080-d nginx: his-ser-1.3.4

FIG. 8 is an example 800 of additional details of the operations performed by the container migration module in FIG. 7, in accordance with embodiments of the present invention. Example 800 includes old server 702, new server 704, container 706, and container 712, as described above in the discussion of FIG. 7. Example 800 also includes mapping data, which maps volume 802, volume 804, and image 806 to volume 808, volume 810, and image 812, respectively. Because container migration module 204 determines that there was no conflict regarding volume /xx-vol (i.e., the directory name /xx-vol is available in new server 704 at the initiation of the migration of container 706). Further, container migration module 204 uses secure copy protocol (scp) to copy the data in the directory /xx-vol in old server 702 into the directory with the same name in new server 704 (i.e., directory /xx-vol in new server 704) as part of the migration of container 706 from old server 702 to new server 704 to become migrated container 712.

Because container migration module 204 determines that there is a conflict regarding /xx-vol2 (i.e., the directory name /xx-vol2 is already being used in new server 704 prior to and at the initiation of the migration of container 706), container migration module 204 identifies directory /xx-vol2-vol as a directory that is available in new server 704, so that /xx-vol2 maps to /xx-vol2-vol. Container migration module 204 uses scp to copy the data in directory /xx-vol2 in old server 702 into directory /xx-vol2-vol in new server 704 as part of the migration of container 706 to new server 704 to become migrated container 712. Further, container migration module 204 automatically updates the metadata from /xx-vol2 in container 706 to /xx-vol2-vol in the migrated container 712.

Container migration module 204 also updates the image by using scp to copy the image 806 into image 812 in new server 704 and replace “latest” with “his-ser-1.3.4” (i.e., the new tag automatically provided by container migration module 204). Further, container migration module 204 automatically updates the metadata from “nginx: latest” in container 706 to “nginx: his-ser-1.3.4” in the migrated container 712.

Container migration module 204 includes the updated metadata in the run command, as indicated by the boldface type in the docker run command shown in FIG. 8. Container migration module 204 executes the aforementioned run command to start migrated container 712 in new server 704.

FIG. 9 is an example 900 of operations performed by the container verification module, which is included in the modules in FIG. 2, and where the operations are included in the process of FIG. 3, in accordance with embodiments of the present invention. Example 900 includes old server 702, new server 704, container 706, and container 712, as described above in the discussion of FIG. 7. After container migration module 204 starts the migrated container 712 in new server 704 by executing the docker run command shown in FIG. 8, container verification module 206 automatically selects a verification method that uses software-based probes 902 and validates new server 704 by performing reliable validation method(s).

Container verification module 206 selects (e.g., randomly selects) service(s) in container 706 running in old server 702 and tests the selected service(s) by using probes 902 to automatically verify old server 702 by applying verification rules. In one embodiment, probes 902 and the verification rules are employed by container verification module 206 as described above in the discussion of FIG. 2 and FIG. 3. Container verification module 206 automatically selects a probe verification method that is determined to be reliable based on a determination that the probe verification passes (i.e., indicates that container 706 is alive and healthy). Container verification module 206 validates new server 704 by using reliable validation method(s) on service(s) running in container 712 that are the same as the aforementioned selected service(s) in container 706. Container verification module 206 performs the reliable validation method(s) to determine that the behavior of the service(s) in container 712 matches the behavior of the selected service(s) in container 706.

In other embodiments, container verification module 306 uses other probes in addition to or instead of the probes listed in probes 902.

The descriptions of the various embodiments of the present invention have been presented herein for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
retrieving image metadata from an image of a container being migrated from an old server to a new server;
extracting, from the retrieved image metadata, information related to migrating containers and analyzing the extracted information;
creating a new manifest that includes migration information based on the analyzed extracted information;
analyzing metadata of the container and generating a new startup command by combining the analyzed metadata of the container with other metadata of the container, new service port information, and disk usage;
based on the analyzed metadata of the container, uploading media including disks and images to a directory in the new server;
starting a service in the new server by running the new startup command; and
verifying a startup of the container in the new server, wherein the starting the service is included in the startup.

2. The method of claim 1, wherein the retrieving the image metadata, the extracting the information related to migrating the containers, the creating the new manifest, the analyzing the extracted information, the analyzing the metadata of the container, the generating the new startup command, the uploading the media, the starting the service, and the verifying the startup of the container provide a completion of a migration of the container from the old server to the new server without using and without having access to a compose file associated with the old server, wherein the compose file includes information about configuring containers in the old server and information about starting the containers in the old server in a specified sequence.

3. The method of claim 1, further comprising:
based on the analyzed metadata, detecting a conflict between the old server and the new server by determining that a port used by a service provided by the container in the old server has an identifier that is already being used by another service in the new server prior to a migration of the container from the old server to the new server; and
in response to the detecting the conflict, automatically identifying another port available in the new server, wherein the generating the new startup command includes inserting the identified other port into the new startup command.

4. The method of claim 1, further comprising:
based on the analyzed metadata, detecting a conflict between the old server and the new server by determining that a mounting volume used by the service provided by the container in the old server has an identifier that is already being used by another service in the new server prior to a migration of the container from the old server to the new server; and
in response to the detecting the conflict, automatically identifying another mounting volume available in the new server, wherein the generating the new startup command includes inserting the identified other mounting volume into the new startup command.

5. The method of claim 1, further comprising:
based on the analyzed metadata, detecting an update to a software version used by a service provided by the container in the old server; and
in response to the detecting the update, automatically identifying a new tag specifying the update to the software version, wherein the generating the new startup command includes inserting the new tag to specify the update to the software version.

6. The method of claim 1, further comprising:
automatically verifying the container in the old server by using (i) httpGet liveProbe if an outbound port exists in the old server and using a tcp socket probe if the httpGet liveProbe fails, or (ii) a pre-defined exec command; and
automatically selecting a probe verification method based on the verification of the container in the old server, where the verifying the startup of the container in the new server includes validating the new server by using the selected probe verification method.

7. The method of claim 6, wherein the validating the new server includes:
determining that a validation of the new server fails by using the selected probe verification method, the validation failing being an indication that the startup of the container in the new server is abnormal; and
in response to the indication that that startup of the container in the new server being abnormal, repeating a migration and a validation of the container.

8. A computer system comprising:
a processor set;
one or more computer-readable storage media; and
program instructions stored on the one or more computer-readable storage media to cause the processor set to perform operations comprising:
retrieving image metadata from an image of a container being migrated from an old server to a new server;
extracting, from the retrieved image metadata, information related to migrating containers and analyzing the extracted information;
creating a new manifest that includes migration information based on the analyzed extracted information;
analyzing metadata of the container and generating a new startup command by combining the analyzed metadata of the container with other metadata of the container, new service port information, and disk usage;
based on the analyzed metadata of the container, uploading media including disks and images to a directory in the new server;
starting a service in the new server by running the new startup command; and
verifying a startup of the container in the new server, wherein the starting the service is included in the startup.

9. The computer system of claim 8, wherein the retrieving the image metadata, the extracting the information related to migrating the containers, the creating the new manifest, the analyzing the extracted information, the analyzing the metadata of the container, the generating the new startup command, the uploading the media, the starting the service, and the verifying the startup of the container provide a completion of a migration of the container from the old server to the new server without using and without having access to a compose file associated with the old server, wherein the compose file includes information about configuring containers in the old server and information about starting the containers in the old server in a specified sequence.

10. The computer system of claim 8, wherein the operations further comprise:
based on the analyzed metadata, detecting a conflict between the old server and the new server by determining that a port used by a service provided by the container in the old server has an identifier that is already being used by another service in the new server prior to a migration of the container from the old server to the new server; and
in response to the detecting the conflict, automatically identifying another port available in the new server, wherein the generating the new startup command includes inserting the identified other port into the new startup command.

11. The computer system of claim 8, wherein the operations further comprise:
based on the analyzed metadata, detecting a conflict between the old server and the new server by determining that a mounting volume used by the service provided by the container in the old server has an identifier that is already being used by another service in the new server prior to a migration of the container from the old server to the new server; and
in response to the detecting the conflict, automatically identifying another mounting volume available in the new server, wherein the generating the new startup command includes inserting the identified other mounting volume into the new startup command.

12. The computer system of claim 8, wherein the operations further comprise:
based on the analyzed metadata, detecting an update to a software version used by a service provided by the container in the old server; and
in response to the detecting the update, automatically identifying a new tag specifying the update to the software version, wherein the generating the new startup command includes inserting the new tag to specify the update to the software version.

13. The computer system of claim 8, wherein the operations further comprise:
automatically verifying the container in the old server by using (i) httpGet liveProbe if an outbound port exists in the old server and using a tcp socket probe if the httpGet liveProbe fails, or (ii) a pre-defined exec command; and
automatically selecting a probe verification method based on the verification of the container in the old server, where the verifying the startup of the container in the new server includes validating the new server by using the selected probe verification method.

14. The computer system of claim 13, wherein the validating the new server comprises:
determining that a validation of the new server fails by using the selected probe verification method, the validation failing being an indication that the startup of the container in the new server is abnormal; and
in response to the indication that that startup of the container in the new server being abnormal, repeating a migration and a validation of the container.

15. A computer program product comprising:
one or more computer-readable storage media; and
program instructions stored on the one or more computer-readable storage media to perform operations comprising:
retrieving image metadata from an image of a container being migrated from an old server to a new server;
extracting, from the retrieved image metadata, information related to migrating containers and analyzing the extracted information;
creating a new manifest that includes migration information based on the analyzed extracted information;
analyzing metadata of the container and generating a new startup command by combining the analyzed metadata of the container with other metadata of the container, new service port information, and disk usage;
based on the analyzed metadata of the container, uploading media including disks and images to a directory in the new server;
starting a service in the new server by running the new startup command; and
verifying a startup of the container in the new server, wherein the starting the service is included in the startup.

16. The computer program product of claim 15, wherein the retrieving the image metadata, the extracting the information related to migrating the containers, the creating the new manifest, the analyzing the extracted information, the analyzing the metadata of the container, the generating the new startup command, the uploading the media, the starting the service, and the verifying the startup of the container provide a completion of a migration of the container from the old server to the new server without using and without having access to a compose file associated with the old server, wherein the compose file includes information about configuring containers in the old server and information about starting the containers in the old server in a specified sequence.

17. The computer program product of claim 15, wherein the operations further comprise:
based on the analyzed metadata, detecting a conflict between the old server and the new server by determining that a port used by a service provided by the container in the old server has an identifier that is already being used by another service in the new server prior to a migration of the container from the old server to the new server; and
in response to the detecting the conflict, automatically identifying another port available in the new server, wherein the generating the new startup command includes inserting the identified other port into the new startup command.

18. The computer program product of claim 15, wherein the operations further comprise:
based on the analyzed metadata, detecting a conflict between the old server and the new server by determining that a mounting volume used by the service provided by the container in the old server has an identifier that is already being used by another service in the new server prior to a migration of the container from the old server to the new server; and
in response to the detecting the conflict, automatically identifying another mounting volume available in the new server, wherein the generating the new startup command includes inserting the identified other mounting volume into the new startup command.

19. The computer program product of claim 15, wherein the operations further comprise:
based on the analyzed metadata, detecting an update to a software version used by a service provided by the container in the old server; and
in response to the detecting the update, automatically identifying a new tag specifying the update to the software version, wherein the generating the new startup command includes inserting the new tag to specify the update to the software version.

20. The computer program product of claim 15, wherein the operations further comprise:
automatically verifying the container in the old server by using (i) httpGet liveProbe if an outbound port exists in the old server and using a tcp socket probe if the httpGet liveProbe fails, or (ii) a pre-defined exec command; and
automatically selecting a probe verification method based on the verification of the container in the old server, where the verifying the startup of the container in the new server includes validating the new server by using the selected probe verification method.
